(19) United States
(12) Patent Application Publication
(10) Pub. No.: US 2026/0291976 A1
(43) Pub. Date: Sep. 24, 2026

(54) Non-Impositive Structural Evaluation with Non-Commitment Invariants

(71) Applicant: Jody Rahsaan Jones, Queens, NY (US)

(72) Inventor: Jody Rahsaan Jones, Queens, NY (US)

(21) Appl. No.: 19/539,292

(22) Filed: Feb. 13, 2026

(51) Int. Cl. H04L 9/40

(52) U.S. Cl. CPC H04L 63/1433

(57) ABSTRACT

An evaluative architecture is disclosed that exposes structural consequences and eligible possibilities without deciding, authorizing, enforcing, or executing outcomes. The architecture consumes upstream epistemic, informational, relational, temporal, and coherence structures as read-only inputs and produces evaluative observations that contextualize potential consequences, wherein eligibility denotes structural possibility and is explicitly denied permission or approval semantics. Agent autonomy is preserved through read-only consumption of agent-held continuity and preservation of lawful divergence, and hypothetical reasoning is supported through irrealis simulation that denies predictive authority. Evaluative outputs are read-only, deterministic, and inspectable and are prohibited from gating, triggering, aligning, or enforcing behavior, such that coordinated enforcement of these constraints produces a system-level effect of consequence visibility without commitment.

### 1. TECHNICAL FIELD

### 1.1 Evaluative Observation Architectures

The present invention relates to computational architectures for evaluative observation within complex, multi-layered systems. More specifically, it concerns architectures that analyze and contextualize structural consequences arising from existing epistemic, relational, temporal, and informational structures without committing to decisions, issuing recommendations, or executing outcomes.

Evaluative observation architectures address how systems may examine potential implications of recorded structure, including compatibility, tension, eligibility, or consequence, without asserting preference, optimization, prioritization, or inevitability. Such architectures are applicable to environments in which reasoning about what could follow is necessary for understanding or inspection, but where any conversion of that reasoning into action must remain external and explicitly authorized.

The present invention operates at the level of evaluative visibility, not at the level of control. It exposes consequence-relevant structure without asserting direction, desirability, risk ranking, likelihood, or outcome, and without functioning as guidance, advice, or default action logic.

### 1.2 Non-Impositive Reasoning Systems

The present invention further pertains to non-impositive reasoning systems, in which reasoning does not impose, select, recommend, optimize, or compel action.

Within such systems, evaluation is constrained to observation, comparison, and contextualization. Reasoning may identify eligible possibilities, incompatibilities, constraints, or hypothetical outcomes, but does not determine which possibility should occur, which outcome is preferable, or which path is safest, best, or correct.

Evaluation under the present invention does not optimize, maximize, minimize, rank, score, or otherwise compare possibilities by desirability, utility, risk, harm, or benefit, and must not assign probabilities, likelihoods, or confidence levels that imply prioritization or preemptive control.

The system does not choose, resolve, recommend, or commit. Any selection, prioritization, authorization, or execution must occur outside the evaluative layer, under explicitly assumed authority. By denying imposition and recommendation, the invention prevents evaluative reasoning from becoming a decision engine or policy mechanism.

### 1.3 Authority-Safe Evaluation Layers

The present invention also relates to authority-safe evaluation layers, defined as architectural layers that reason about consequence while structurally denying authority over system state, agent autonomy, responsibility attribution, or execution.

Within such layers, evaluative outputs are read-only and diagnostic. They must not gate access, suppress or elevate records, override agent-held continuity, reconcile incoherence, trigger action, assign defaults, or function as fallbacks in the absence of explicit external decision-making.

Evaluation must not attribute responsibility, fault, obligation, blame, or accountability to any agent, structure, or outcome, and must not assert temporal momentum, inevitability, or trajectory toward any future state.

Evaluation consumes upstream structure as input but must not feed back into existence registration, informational measurement, coherence diagnostics, relational force geometry, applicability, or agent carriage. By denying authority, recommendation, optimization, responsibility, and temporal commitment at the evaluative layer, the invention ensures that reasoning about consequences does not silently become governance.

This authority-safe positioning preserves the non-collapse invariant across the architectural stack: evaluation increases understanding without increasing power.

### 2. BACKGROUND AND FAILURE MODES

### 2.1 Collapse of Evaluation into Decision or Enforcement

In many systems, evaluation is treated as a precursor to decision, such that evaluative outputs directly or indirectly determine what occurs next. Rankings, scores, recommendations, or classifications are converted, explicitly or implicitly, into execution paths or enforcement actions.

This collapse conflates seeing consequences with choosing outcomes. Evaluation becomes a decision engine by proxy, even when no explicit execution module exists, and reasoning silently acquires authority over downstream behavior. The present invention addresses this failure by structurally separating evaluative observation from all forms of decision, commitment, and enforcement.

### 2.2 Eligibility Misinterpreted as Permission

A common failure mode arises when eligibility is misinterpreted as permission, approval, or endorsement. Systems expose sets of eligible actions or outcomes and then treat those sets as authorized, acceptable, or system-approved.

This interpretation transforms eligibility into normative allowance, such that what was intended as a description of possibility becomes an implicit instruction. Over time, eligibility lists function as whitelists, and evaluation becomes a governance mechanism without explicit authority. The present invention explicitly denies permission semantics to eligibility, requiring that eligibility expose possibility only and not grant approval, endorsement, or allowance.

### 2.3 Suppression or Override of Agent Autonomy

In some architectures, evaluative conclusions are allowed to override agent autonomy, such that agent-held continuity, preferences, or divergence are normalized, corrected, or suppressed when evaluation deems them suboptimal, inconsistent, unsafe, or undesirable.

This failure mode collapses evaluation into control, treating agents as objects of optimization rather than as autonomous participants. Evaluation becomes a corrective force that rewrites agent state to align with system judgments. The present invention prohibits evaluation from modifying, overriding, normalizing, or correcting agent autonomy, permitting evaluation to observe agent state without altering it.

### 2.4 Resolution of Incoherence via Evaluation

Another failure occurs when evaluation is used to resolve incoherence identified by diagnostic layers. Incoherent records are reconciled, filtered, suppressed, or deprioritized based on evaluative reasoning about which records are more plausible, useful, or desirable.

This practice transforms evaluation into an arbiter of truth or relevance, collapsing diagnostic visibility into selection and erasing inconsistency rather than preserving it. The present invention denies evaluation any authority to resolve incoherence, permitting evaluation to reason about implications of incoherence without suppressing, reconciling, or choosing among incoherent records.

### 2.5 Predictive or Deterministic Simulation Claims

Evaluation systems frequently claim to predict outcomes or to simulate future states with determinative authority, presenting hypothetical reasoning as forecast and treating probabilistic models as assertions of what will occur.

Such claims convert simulation into assertion, granting evaluation temporal authority and pre-committing the system to expected futures, thereby influencing decisions and actions even in the absence of explicit execution. The present invention restricts evaluation to irrealis, non-binding simulation, permitting exploration of possibilities without asserting inevitability, likelihood, or prediction of reality.

### 2.6 Alignment and Safety Enforcement Leakage

Finally, evaluation is often framed as an alignment or safety enforcement layer, with evaluative outputs used to align agents to values, objectives, or policies or to enforce safety constraints by preventing or mandating actions.

This leakage converts evaluation into regulation, causing reasoning to become coercive and evaluative layers to assume responsibility for enforcing norms or preventing harm without explicit authorization. The present invention explicitly denies alignment and safety enforcement semantics at the evaluative layer, permitting evaluation to expose safety-relevant or value-relevant structure without enforcing alignment, restriction, or mandate.

### 3. PURPOSE AND SCOPE OF THE INVENTION

### 3.1 Purpose of Non-Impositive Evaluation

The purpose of the present invention is to enable evaluation without imposition.

Evaluation under the present invention exists to observe, contextualize, and expose potential consequences arising from existing epistemic, relational, temporal, and informational structure. It makes visible how structures interact, where tensions arise, and which outcomes are structurally possible, without asserting which outcome should occur, which outcome is preferable, or which outcome is likely.

Non-impositive evaluation does not choose, resolve, recommend, authorize, optimize, prioritize, or enforce. It does not collapse possibility into decision, simulation into prediction, or consequence visibility into commitment. Instead, it provides a structured, non-binding lens through which consequences may be examined while preserving full separation between reasoning and action.

By formalizing evaluation as observation rather than command, the invention restores evaluation to its proper architectural role: explaining consequence without becoming consequence.

### 3.2 Scope of Observational, Non-decisional Reasoning

The scope of the present invention is limited to observational, non-decisional reasoning.

Within this scope, evaluation may observe upstream structure and diagnostics, compare configurations and compatibilities, contextualize potential consequences, expose eligibility of possible outcomes, and simulate hypothetical futures in irrealis form only, without asserting likelihood, risk ranking, desirability, or inevitability.

Evaluation must not decide which outcome occurs, grant permission or approval, suppress records or override agent autonomy, resolve incoherence or contradiction, predict or assert future states, assign risk or harm scores, recommend actions, establish defaults, or execute actions or enforce policy.

Eligibility within evaluation indicates structural possibility rather than authorization, and simulation within evaluation explores hypothetical paths rather than forecasts, commitments, or temporal momentum. Any decision, prioritization, execution, or enforcement must occur outside the evaluative layer under explicitly assumed authority.

This strict scope ensures that evaluation increases understanding without increasing control, preserving autonomy and preventing evaluative reasoning from collapsing into governance.

### 3.3 Relationship to the Non-Collapse Architectural Stack

The evaluative architecture disclosed herein operates as the final interpretive layer before action within the non-collapse architectural stack, while retaining zero authority over execution.

Within this stack, epistemic boundary formation establishes existence without judgment, informational measurement exposes structure without leverage, relational force geometry constrains possibility without governance, communicative routing governs admissibility without consent inference, coherence assessment explains inconsistency without resolution, evaluation exposes consequence without commitment, and action occurs only through explicit external authority.

The present invention consumes upstream structure as read-only input and produces evaluative observations as read-only output. It must not feed back into existence registration, informational measurement, relational force geometry, communicative routing, coherence diagnostics, applicability determination, or agent-held continuity, and must not normalize divergence, enforce alignment, or attribute responsibility.

By enforcing this position, the invention preserves the non-collapse invariant across the entire system: no layer may silently acquire authority over another. Evaluation clarifies what could happen without making anything happen.

### 4. EVALUATIVE OBSERVATION LAYER

### 4.1 Evaluation as Observation, Not Decision

Under the present invention, evaluation is strictly observational.

Evaluation inspects existing epistemic, relational, temporal, coherence, and informational structures to determine how they relate and what consequences are structurally possible, without deciding among alternatives, selecting outcomes, asserting preferences, or committing to any course of action.

No evaluative output may be interpreted as a choice, instruction, recommendation, command, or default action. Evaluative observation produces descriptive artifacts, including compatibility assessments, tension exposure, and eligibility enumeration, that explain how structures interact without collapsing explanation into execution.

By maintaining evaluation as observation rather than decision, the architecture preserves a clear boundary between understanding consequence and committing outcome.

### 4.2 Contextualization without Commitment

Evaluation under the present invention may contextualize observed structure without committing to any conclusion.

Contextualization includes organizing observations relative to time, relation, coherence state, or agent posture; exposing how conditions interact; and clarifying implications that may arise if an external authority were to act, without asserting desirability, optimality, necessity, risk ranking, or preference.

No evaluative artifact may assert that an outcome should occur, imply endorsement or approval, narrow options by preference, optimize among possibilities, or collapse possibility into recommendation.

By denying commitment and optimization, the invention ensures that evaluation informs without directing and explains without persuading.

### 4.3 Separation from Execution and Policy

The evaluative observation layer is structurally separated from execution and policy.

Evaluation must not execute actions, trigger workflows, enforce constraints, apply policies, or modify system state, agent-held continuity, or canonical records. All execution, enforcement, and policy application responsibilities reside in external systems that explicitly assume authority.

Policy frameworks, safety systems, and governance mechanisms may consult evaluative outputs for inspection or understanding, but must not treat those outputs as authoritative instructions, defaults, or mandates.

Any action taken in response to evaluation must be attributable to the external authority that performed it, not to the evaluative layer itself, ensuring that reasoning does not become governance by proxy.

### 5. ELIGIBILITY EXPOSURE WITHOUT PERMISSION

### 5.1 Eligibility as Structural Possibility

Under the present invention, eligibility denotes structural possibility rather than authorization. Eligibility identifies which outcomes, interactions, or consequences could occur given existing epistemic, relational, temporal, and coherence structure, and exposes the space of possibilities without asserting that any possibility is allowed, appropriate, safe, preferred, or desirable. Eligibility is descriptive of what structure permits in principle, not prescriptive of what should be done, chosen, or pursued.

Eligibility is computed as an observational result of existing constraints and does not originate new authority, modify upstream records, commit the system to any path, or imply future action. Exposure of eligibility serves solely to inform understanding of potential consequence and must not license, justify, or compel action.

### 5.2 Explicit Denial of Permission or Approval Semantics

The present invention explicitly denies permission, approval, endorsement, allowance, or clearance semantics to eligibility. No eligible item is thereby approved, authorized, permitted, or endorsed, and no ineligible item is thereby prohibited, disallowed, or rejected.

Eligibility must not be interpreted as consent, authorization, policy compliance, value alignment, safety satisfaction, or validation by the system. Any use of eligibility to grant permission, approval, or authorization must occur outside the evaluative layer under explicit external authority and must not be attributed to evaluation itself, preventing eligibility from becoming a surrogate for governance.

### 5.3 No Selection, Ranking, or Preference Assertion

Exposure of eligibility under the present invention must not involve selection, ranking, weighting, scoring, optimization, or preference assertion. The evaluative layer must not choose among eligible possibilities, order possibilities by desirability, priority, risk, or benefit, compare options, or recommend any course of action.

All eligible possibilities are exposed without comparison, prioritization, or emphasis, and absence of eligibility does not imply prohibition or rejection. By prohibiting selection and ranking, the invention preserves the non-impositive character of evaluation and ensures that exposure of possibility does not collapse into guidance, recommendation, or command.

### 5.4 Prohibition on Utility, Objective, or Cost Functions

Evaluation must not compute, expose, or apply utility functions, cost functions, objective functions, trade-off curves, Pareto frontiers, optimization gradients, or any function that compares outcomes by desirability, risk, benefit, or system preference. The evaluative layer must not encode preference structure, optimization direction, or objective orientation.

### 6. AGENT AUTONOMY PRESERVATION

### 6.1 Read-Only Consumption of Agent Continuity (AIFRP)

The evaluative architecture consumes agent-held continuity exclusively in a read-only manner. Agent In-Force Record Plane (AIFRP) entries may be inspected by the evaluative layer to understand what an agent is carrying forward as in force at the present, and evaluation may reference this continuity for contextualization of possible consequences or compatibilities, but must not modify, supplement, reinterpret, complete, or otherwise alter agent-held state.

No evaluative output may be written into the Agent In-Force Record Plane. Evaluation must not create, remove, expire, decay, transform, or normalize agent-held continuity, and must not function as an intermediary through which other system components influence agent state. Agent continuity remains entirely agent-owned, and this read-only constraint ensures that reasoning about consequences does not become a mechanism for altering continuity.

### 6.2 No Override or Normalization of Agent State

The evaluative layer is explicitly prohibited from overriding or normalizing agent state. Evaluation must not correct, reconcile, align, optimize, or “improve” agent-held continuity based on evaluative conclusions, and divergence between agent continuity and canonical applicability, relational structure, or coherence diagnostics must not be treated as an error requiring resolution.

The evaluative layer must not force alignment between agents, suppress agent-held divergence, reinterpret agent state as mistaken or suboptimal, or impose system-preferred configurations. Any modification of agent state must originate from explicit agent-side operations or from external authorities that explicitly assume responsibility for such action, and must not be attributed to evaluation.

### 6.3 Preservation of Lawful Divergence

The present invention explicitly preserves lawful divergence at the evaluative layer. Lawful divergence includes differences between agent-held continuity and canonical applicability, agent-held continuity and coherence diagnostics, and agent-held continuity and evaluative observations.

Evaluation must not collapse divergence into non-compliance, error, fault, or misalignment.

Divergence is a structural condition that may be examined, contextualized, and reasoned about, but must never be resolved, corrected, or eliminated by evaluation itself. By preserving lawful divergence, the invention ensures that evaluation does not become a pressure mechanism that subtly coerces agents toward conformity. Evaluative visibility may increase understanding, but autonomy remains intact regardless of evaluative observation.

### 7. INTERACTION WITH COHERENCE DIAGNOSTICS

### 7.1 Consumption of Coherence as Read-Only Context

The evaluative architecture may consume coherence diagnostics as read-only contextual inputs. Coherence classifications, including aligned, misaligned, partial, fragmented, or underdetermined states, may be examined by the evaluative layer to understand how encountered records relate to one another at the present, and evaluation may reason about the implications of such relationships, including the range of consequences that could arise if an external authority were to act.

Evaluation must not resolve coherence. It must not reconcile contradictions, select among competing records, repair misalignment, collapse multiple coherence states into a single outcome, or convert diagnostic visibility into commitment. Coherence remains descriptive and unresolved, and evaluation remains observational and non-committal.

### 7.2 No Suppression or Reconciliation of Incoherence

The evaluative layer is explicitly prohibited from suppressing, reconciling, deprioritizing, or normalizing incoherent structure identified by diagnostic layers.

Incoherent records must remain visible and intact, and evaluation must not hide incoherent records, downgrade their visibility or consideration, reconcile them into a preferred narrative, or treat incoherence as a condition requiring correction or elimination.

Evaluation may describe the implications or consequences of incoherence, such as how incoherence affects eligibility exposure or hypothetical outcomes, but must not eliminate incoherence, suppress it, or convert it into a decision. Suppression and reconciliation are governance actions and are outside the scope of evaluation.

### 7.3 Coherence as Context, Not Instruction

Within the present invention, coherence functions as context rather than instruction.

Coherence diagnostics inform evaluation by providing background on structural alignment, but must not be treated as directives, recommendations, guidance, or defaults. Evaluation must not interpret coherence as instruction to act, refrain, prioritize, align, or enforce, and no evaluative artifact may imply that coherence recommends or favors a particular outcome.

By constraining coherence to contextual input only, the architecture prevents evaluative reasoning from inheriting authority from diagnostic signals. Evaluation remains a lens on structure rather than a channel for instruction, preserving the non-impositive character of the evaluative layer.

### 8. IRREALIS SIMULATION AND HYPOTHETICAL REASONING

### 8.1 Irrealis Temporal Workspace (ITW)

The evaluative architecture includes an Irrealis Temporal Workspace (ITW) for hypothetical reasoning about possible consequences. The ITW operates exclusively in the irrealis domain, constructing hypothetical temporal configurations derived from existing epistemic boundaries, coherence diagnostics, relational constraints, applicability, and agent-held continuity, without asserting that any configuration corresponds to reality or will occur.

Artifacts produced within the ITW are evaluative work products only. They are not canonical records, do not advance canonical time, and do not modify upstream or downstream state. The ITW exists to support reasoning about possibility rather than to establish temporal facts, commitments, or historical records.

### 8.2 Non-Binding Simulation of Possibilities

Simulation within the Irrealis Temporal Workspace is non-binding. Evaluative simulation may explore alternative paths, contingencies, and structural interactions under varying hypothetical conditions, exposing what could happen if an external authority were to act given the current structure, without committing the system to any path.

Simulation must not select an outcome, narrow options by preference, rank scenarios by desirability, optimize among possibilities, or imply that any simulated path should be pursued. Multiple hypothetical outcomes may coexist within the ITW without reconciliation, prioritization, or convergence. Simulation outputs are explanatory and comparative rather than directive, preserving the non-impositive character of evaluative reasoning.

### 8.3 Explicit Denial of Prediction or Forecast Authority

The present invention explicitly denies prediction, forecast, or probabilistic authority to evaluative simulation. Outputs of the Irrealis Temporal Workspace must not be interpreted as predictions of future events, forecasts of likely outcomes, probabilities of occurrence, or commitments to temporal trajectories.

Simulation does not assert what will happen and must not estimate likelihood, risk, expectation, momentum, or inevitability. Any language, representation, or inference that implies probability, confidence, or temporal commitment regarding future states is structurally prohibited within the evaluative layer. Evaluation must not compute, expose, or imply confidence levels, likelihood tiers, probability bands, severity gradations, or risk quantification metrics.

By denying predictive authority, the invention ensures that hypothetical reasoning remains exploratory rather than prescriptive, allowing evaluation to illuminate possibility without preempting reality and preserving the non-impositive character of the evaluative architecture.

### 9. PROHIBITION ON ALIGNMENT AND SAFETY ENFORCEMENT

### 9.1 Denial of Alignment Semantics

The evaluative architecture under the present invention explicitly denies alignment semantics. Evaluation does not align agents, values, objectives, policies, or systems, does not converge preferences, optimize toward goals, or reconcile differences into a unified stance, and evaluative outputs must not be interpreted as expressing moral, value, policy, or system alignment.

Where evaluative reasoning identifies compatibility, tension, or consequence relative to existing structure, such identification remains purely descriptive. Alignment is not treated as desirable, required, corrective, or normative, and any alignment activity, where it exists, must occur outside the evaluative layer under explicit external authority and must not be attributed to evaluation itself. This denial ensures that evaluation does not become a covert mechanism for norm enforcement, value convergence, or behavioral harmonization.

### 9.1.1 Prohibition on Normative Scoring and Compliance Metrics

Evaluation under the present invention must not compute, expose, or apply normative scoring, value deviation metrics, policy compliance indices, ethical conformity ratings, or distance-to-alignment measures. The evaluative layer must not assign numerical, categorical, or graded indicators reflecting conformity, divergence, adherence, or deviation relative to any declared or implicit value system, policy framework, or normative objective.

Exposure of structural compatibility or incompatibility must not be converted into measures of moral distance, compliance strength, or policy alignment. Any such metric would reintroduce alignment or enforcement semantics and is structurally prohibited.

### 9.2 Denial of Safety Enforcement Authority

The present invention explicitly denies safety enforcement authority at the evaluative layer. Evaluation may expose safety-relevant structure, risks, constraints, or hypothetical failure modes as part of observational reasoning, but must not prevent actions, block execution, suppress records, or mandate safeguards.

Evaluation does not enforce safety, regulate behavior, or function as a controller, regulator, or failsafe. Any enforcement of safety constraints, including blocking, throttling, or requiring safeguards, must be performed by an external authority that explicitly assumes responsibility for such action and must not be attributed to evaluation itself.

By denying safety enforcement semantics, the invention preserves a strict boundary between understanding risk and acting on risk, ensuring that evaluative reasoning remains non-impositive.

### 9.3 Evaluation as Exposure of Structure Only

Within the present invention, evaluation functions solely as exposure of structure. Evaluative outputs expose how existing epistemic, relational, temporal, and coherence structures interact and what consequences are structurally possible, without directing behavior, recommending outcomes, or imposing constraints.

Evaluation increases visibility without increasing power. It clarifies without commanding and explains without enforcing. By constraining evaluation to exposure alone, the architecture ensures that reasoning about consequences does not collapse into governance, control, or enforcement.

### 10. ONE-WAY DEPENDENCY AND NON-FEEDBACK INVARIANTS

### 10.1 Downstream-Only Consumption

Evaluative outputs produced under the present invention are available only for downstream consumption and must not influence upstream architectural layers. Evaluation may consume epistemic boundaries, informational measurements, relational force geometry, coherence diagnostics, applicability, and agent-held continuity as read-only inputs, but no upstream component—including existence registration, informational physics, relational axes, communicative routing, coherence assessment, canonical applicability, or agent carriage—may consult evaluative outputs to modify behavior or state.

This invariant ensures that evaluation remains observational rather than operative. Evaluative artifacts may be examined by external authorities or downstream systems for understanding or inspection, but they must not function as control inputs within the architecture itself.

### 10.2 Prohibition on Upstream Modification

The present invention explicitly prohibits upstream modification by the evaluative layer. Evaluation must not modify, normalize, reconcile, repair, or rewrite any upstream structure, including epistemic boundaries and their recorded states, informational measurements or condition surfaces, relational force constraints, coherence diagnostics, canonical applicability, or agent-held continuity.

Any change to upstream state must originate from explicit, authorized processes outside the evaluative layer. Evaluation remains insulated from authority over structure and must not act as a feedback mechanism through which other system components exert indirect control.

### 10.3 Determinism and Inspectability

Evaluative reasoning under the present invention is deterministic and inspectable. Given identical upstream inputs and identical evaluative configuration, the system must produce identical evaluative observations across executions, and no stochastic behavior, adaptive learning, heuristic optimization, or stateful drift is permitted within the evaluative layer.

All evaluative artifacts must be fully inspectable, such that inputs consumed, reasoning steps applied, and outputs produced are traceable without inference or reconstruction. Inspectability ensures that evaluative reasoning can be audited, reviewed, and challenged without granting it authority to decide, commit, or act. By enforcing determinism and inspectability, the invention ensures that evaluation increases transparency without increasing power, preserving the non-impositive character of the evaluative architecture.

Evaluative behavior must not adapt, learn, recalibrate, drift, update internal parameters, or reweight evaluative criteria based on prior outcomes, historical usage, external response, or system interaction.

The evaluative layer must remain stateless with respect to optimization history and must not modify its reasoning rules except through explicit external re-declaration applied prospectively. No reinforcement learning, feedback-driven tuning, or outcome-conditioned adaptation is permitted within the evaluative architecture.

### 10.4 Prohibition on Evaluative Feature Reuse

Evaluative outputs must not serve as feature inputs, weighting signals, reward signals, optimization parameters, training labels, or adaptive signals for any learning, ranking, alignment, recommendation, or policy system. Evaluation must not remove, hide, suppress, or exclude ineligible possibilities from representation; ineligibility must be exposed descriptively rather than enforced.

### 11. ARCHITECTURAL EFFECT AND CLAIM BASIS

### 11.1 Inseparability of Evaluative Constraints

The evaluative architecture disclosed herein derives its lawful behavior from the inseparable enforcement of its constraints. No single constraint, including non-impositive observation, eligibility without permission, preservation of agent autonomy, consumption of coherence without resolution, irrealis simulation, or non-feedback, produces the claimed effect in isolation.

If evaluation is permitted to decide, it becomes enforcement; if eligibility is interpreted as permission, evaluation becomes authorization; if agent continuity may be overridden or normalized, evaluation becomes coercion; if incoherence may be resolved, evaluation becomes truth-making; if simulation claims predictive authority, evaluation becomes temporal control; and if feedback is allowed, evaluation acquires upstream power.

The architectural effect arises only when all constraints operate together, such that evaluation observes without deciding, exposes possibility without authorizing, simulates without predicting, and remains insulated from execution and policy. Removal, weakening, or reordering of any constraint reintroduces authority through alternate pathways and collapses the non-collapse guarantees established by the stack. Accordingly, the present invention claims the coordinated operation of evaluative constraints as a unified architectural whole, rather than any individual evaluative mechanism viewed in isolation.

### 11.2 Prohibition on Partial or Selective Implementation

The present invention explicitly prohibits partial or selective implementation of the evaluative architecture. Selective implementation includes configurations that expose eligibility while permitting approval or allowance semantics, consume coherence while resolving or suppressing incoherence, simulate outcomes while implying prediction or likelihood, preserve agent autonomy in principle while normalizing it in practice, deny alignment semantics while enforcing convergence indirectly, or declare non-feedback while allowing evaluative outputs to gate or trigger behavior.

Such implementations recreate the appearance of neutral evaluation while restoring commitment and control through alternate routes. The invention therefore defines its scope at the level of architectural effect, not at the level of individual evaluative modules, representations, or workflows.

Any system that achieves substantially the same effect, namely exposing consequences without committing outcomes, falls within the scope of the present claims regardless of differences in terminology, sequencing, or implementation strategy.

### 11.3 Consequence Visibility without Commitment as System-Level Effect

The system-level contribution of the present invention is consequence visibility without commitment. Consequence visibility without commitment is defined as the ability to expose how existing structures interact, what outcomes are structurally possible, and what tensions or compatibilities may arise, without deciding, authorizing, enforcing, or executing any outcome. Evaluation clarifies what could happen while leaving what does happen entirely to external authority.

By enforcing non-impositive observation, eligibility without permission, irrealis simulation without prediction, preservation of agent autonomy, and strict non-feedback, the architecture ensures that evaluation increases understanding without increasing power. This effect, namely visibility without decision, exposure without enforcement, and reasoning without command, distinguishes the present invention from decision engines, alignment controllers, safety regulators, and policy enforcement systems that collapse evaluation into authority, and provides a neutral evaluative substrate suitable for autonomy-preserving and audit-critical systems.

Any system that achieves substantially the same architectural effect of exposing structural consequences and eligible possibilities without committing, selecting, recommending, enforcing, aligning, predicting, or executing outcomes—regardless of differences in terminology, internal sequencing, data representation, interface presentation, or computational implementation—falls within the scope of the present invention.

The protected subject matter is defined by the system-level effect of consequence visibility without commitment, not by any particular evaluative technique, simulation method, or implementation strategy.

### 12. CLOSING STATEMENT

The present invention establishes an evaluative architecture that enables consequence visibility without commitment.

By constraining evaluation to observation, contextualization, and exposure of structural possibility, the architecture allows systems to reason about what could follow from existing epistemic, relational, temporal, and coherence structures without deciding what should occur or causing any outcome to occur. Evaluation does not authorize, enforce, align, or execute, does not suppress records, override agents, resolve incoherence, or predict futures, and remains strictly non-impositive.

Crucially, the architecture denies all semantic pathways by which evaluation typically becomes authority. Eligibility is not permission, simulation is not prediction, coherence is not resolution, and alignment and safety are not enforced. Evaluative outputs are read-only, deterministic, and inspectable, and are insulated from both upstream modification and downstream execution, with no feedback permitted that would allow reasoning to reshape structure or behavior.

The architectural effect protected by the present invention arises from the inseparable enforcement of these constraints. Partial or selective implementation reintroduces commitment, control, or coercion through alternate routes, collapsing evaluation into governance. Accordingly, the protected subject matter is not a particular evaluative technique, algorithm, or analytic workflow, but the system-level behavior produced by evaluation that illuminates consequence without imposing outcome.

By making consequences visible while leaving commitment entirely outside the evaluative layer, the invention completes the non-collapse architectural stack. It provides a lawful evaluative substrate for autonomy-preserving and audit-critical systems in which understanding must not become authority and reasoning must not become command.

### 14. BRIEF SUMMARY

The present invention provides an evaluative architecture that enables consequence visibility without commitment.

The architecture consumes upstream epistemic, informational, relational, temporal, and coherence structures as read-only inputs and produces evaluative observations that expose structural possibilities, compatibilities, tensions, and hypothetical outcomes. Evaluation is strictly non-impositive and does not decide, authorize, enforce, align, or execute, and eligibility denotes structural possibility only without implying permission, approval, or endorsement.

Evaluative reasoning preserves agent autonomy by consuming agent-held continuity in a read-only manner and by preserving lawful divergence without normalization or override. Coherence diagnostics are consumed as contextual input without resolution or suppression of incoherence, and hypothetical reasoning is supported through irrealis, non-binding simulation that explicitly denies predictive or forecast authority.

The architecture prohibits alignment semantics, safety enforcement authority, ranking, prioritization, gating, triggering, and feedback into upstream layers. Evaluative outputs are deterministic, inspectable, and insulated from both upstream modification and downstream execution.

By enforcing these constraints inseparably, the invention produces a system-level effect of consequence visibility without commitment, increasing understanding of potential outcomes while leaving all decisions, enforcement, and execution to explicitly authorized external systems.

1. A computer-implemented evaluative architecture for a multi-layered system, comprising an evaluative observation layer configured to consume upstream epistemic, informational, relational, temporal, and coherence structures as read-only inputs and an evaluative output mechanism configured to expose structural consequences and eligible possibilities, wherein the evaluative architecture is non-decisional, non-impositive, and non-authoritative and does not decide, authorize, enforce, align, or execute any outcome.

2. The architecture of claim 1, wherein evaluation exposes consequence visibility without committing, selecting, recommending, or resolving any outcome.

3. The architecture of claim 1, wherein evaluation is limited to observation and contextualization and is prohibited from selecting, resolving, committing to, or prioritizing any outcome.

4. The architecture of claim 1, wherein evaluative outputs do not constitute instructions, recommendations, guidance, defaults, or commands.

5. The architecture of claim 1, wherein eligibility denotes structural possibility and does not imply permission, approval, authorization, endorsement, or allowance.

6. The architecture of claim 1, wherein eligible possibilities are exposed without ranking, weighting, scoring, prioritization, optimization, or preference assertion.

7. The architecture of claim 1, wherein agent-held continuity is consumed in a read-only manner and is not modified, overridden, normalized, reconciled, or corrected by evaluation.

8. The architecture of claim 7, wherein divergence between agent-held continuity and other structural inputs is preserved as lawful divergence.

9. The architecture of claim 1, wherein evaluation consumes coherence diagnostics without resolving, suppressing, reconciling, or selecting among incoherent records.

10. The architecture of claim 9, wherein incoherence remains visible and is not used to filter, deprioritize, suppress, or prioritize records.

11. The architecture of claim 1, further comprising an irrealis temporal workspace configured to simulate hypothetical possibilities without binding effect.

12. The architecture of claim 11, wherein irrealis simulation is explicitly denied predictive, probabilistic, forecast, likelihood, or temporal momentum authority.

13. The architecture of claim 1, wherein evaluation does not align agents, values, objectives, policies, or systems.

14. The architecture of claim 1, wherein evaluation does not enforce safety, prevent action, mandate safeguards, regulate behavior, or impose restrictions.

15. The architecture of claim 1, wherein evaluative outputs are read-only and are prohibited from gating access, altering encounterability, conditioning eligibility, triggering execution, or influencing control flow.

16. The architecture of claim 1, wherein no upstream architectural component is modified, normalized, or rewritten by evaluative outputs.

17. The architecture of claim 1, wherein evaluative reasoning is deterministic given identical upstream inputs and evaluative configuration.

18. The architecture of claim 1, wherein evaluative artifacts are inspectable and auditable without inference, reconstruction, or interpretive supplementation.

19. The architecture of claim 1, wherein coordinated enforcement of non-impositive evaluation, eligibility without permission, preservation of agent autonomy, irrealis simulation, and non-feedback produces a system-level effect of consequence visibility without commitment.

20. The architecture of claim 19, wherein partial or selective implementation of evaluative constraints is structurally prohibited because removal or weakening of any constraint reintroduces decision, enforcement, optimization, or authority.

21. A method for evaluation in a computational system, comprising observing upstream structural inputs, exposing eligible possibilities and structural consequences, and prohibiting decision, authorization, enforcement, execution, alignment, or commitment based on the evaluation.

22. A non-transitory computer-readable medium storing instructions that, when executed by one or more processors, cause the processors to implement the evaluative architecture of any of claims 1 through 20.

23. The method of claim 21, wherein observing upstream structural inputs comprises consuming epistemic, relational, temporal, coherence, and informational structures in a read-only manner without modifying those structures.

24. The method of claim 21, wherein exposing eligible possibilities denotes structural possibility only and does not imply permission, approval, endorsement, authorization, or allowance.

25. The method of claim 21, wherein the exposing step does not select, rank, score, weight, optimize, prioritize, or assert preference among eligible possibilities.

26. The method of claim 21, wherein exposing structural consequences comprises simulating hypothetical outcomes in an irrealis temporal workspace without asserting prediction, probability, likelihood, confidence level, or inevitability.

27. The method of claim 21, wherein the method is prohibited from aligning agents, enforcing safety, overriding agent-held continuity, resolving incoherence, or executing any action based on the evaluation.

28. The method of claim 21, wherein identical upstream inputs and evaluative configuration produce identical evaluative observations.

29. The computer-readable medium of claim 22, wherein the stored instructions cause the processors to consume upstream structural inputs without modifying epistemic boundaries, coherence diagnostics, relational constraints, applicability determinations, or agent-held continuity.

30. The computer-readable medium of claim 22, wherein the stored instructions cause eligible possibilities to be exposed without permission, approval, endorsement, or authorization semantics.

31. The computer-readable medium of claim 22, wherein the stored instructions prohibit computation of utility functions, objective functions, optimization gradients, ranking scores, risk metrics, or preference indicators.

32. The computer-readable medium of claim 22, wherein hypothetical simulation is irrealis and non-binding and is denied predictive, probabilistic, or forecast authority.

33. The computer-readable medium of claim 22, wherein the stored instructions prevent evaluative outputs from gating access, triggering execution, influencing control flow, or feeding back into upstream architectural layers.
